(19) United States
(12) Patent Application Publication
(10) Pub. No.: US 2007/0279437 A1
(43) Pub. Date: Dec. 6, 2007

(54) Method and apparatus for displaying document image, and information processing device

(76) Inventor: Katsushi Morimoto, Tokyo (JP)

Correspondence Address: DICKSTEIN SHAPIRO LLP, 1825 EYE STREET NW, Washington, DC, 20006-5403, US

(21) Appl. No.: 11/716,575

(22) Filed: Mar. 12, 2007

(30) Foreign Application Priority Data
Mar. 22, 2006 (JP) 2006-079655

(51) Int. Cl. G09G 5/397

(52) U.S. Cl. 345/629

(57) ABSTRACT

A document-image acquiring unit acquires document-image data containing a document with an image size larger than a screen size of a display unit and display control data specifying an order of reading the document and a range of the document-image data to be displayed. A display control unit controls a display of specified range by moving a display area on the screen based on specified order. A determining unit determines whether a width of the range in a line direction in acquired document-image data is wider than a width of the screen. The display control unit moves the display area based on a result of determination by the determining unit.

### CROSS-REFERENCE TO RELATED APPLICATIONS

The present document incorporates by reference the entire contents of Japanese priority document, 2006-079655 filed in Japan on Mar. 22, 2006.

### BACKGROUND OF THE INVENTION

1. Field of the Invention

The present invention relates to a technology for controlling a display of document-image data having an area wider than a screen size of a display unit.

2. Description of the Related Art

Technological development of a liquid crystal panel allows an increase in opportunity to display a document or an image on a portable terminal such as Personal Digital Assistants (PDA) or a mobile phone in addition to a Personal Computer (PC).

In association with the increase in the opportunity to view such a document or an image, a problem arises such that what type of document should be offered to the portable terminal. In other words, because portable terminals have screens of a different size for each model, it is difficult to create a document specific to the individual portable terminals.

If a format of documents is a HyperText Markup Language (HTML), the documents can be displayed on the portable terminal, but most of the documents are Web pages created mainly for PCs. Therefore, when the document is displayed on the screen of the portable terminal, the format is broken, which makes it difficult to visually recognize the document.

On the other hand, there are several technologies provided to display image data obtained through scanning a paper document such as a book, to users (for example, Japanese Patent Application Laid-Open No. H09-305345).

In the conventional technology described as above, because of the image data, even if it is displayed on the portable terminal, the format is never broken. Besides, a character size can be changed by reducing or enlarging the image data, thus, the user can easily read the document.

In the conventional technology, however, it is assumed to display the document on a monitor of large size to some extent, and therefore, even if characters of image data including a document can be read on the portable terminal, the image data has to be moved to read an entire document, which is quite troublesome.

For example, when the image data is provided with multiple columns, the user finishes reading one column and moves the display to the next column. However, the movement requires moving the image data from the end of an arbitrary column to the head of the next column.

### SUMMARY OF THE INVENTION

It is an object of the present invention to at least partially solve the problems in the conventional technology.

An apparatus for displaying a document-image according to one aspect of the present invention includes a display unit that displays an image on a screen; a document-image acquiring unit that acquires document-image data containing a document with an image size larger than a screen size of the display unit and display control data specifying an order of reading the document and a range of the document-image data to be displayed; a display control unit that controls, when displaying the document-image data, a display of specified range by moving a display area on the screen based on specified order; and a determining unit that determines whether a width of the range in a line direction in acquired document-image data is wider than a width of the screen. When it is determined that the width of the range is narrower than the width of the screen, the display control unit moves the display area in a direction perpendicular to the line direction.

An information processing device according to another aspect of the present invention includes a document-image acquiring unit that acquires document-image data containing a document; a document-element extracting unit that extracts a document element indicating a predetermined unit of document from acquired document-image data; a reading-order specifying unit that specifies an order of reading extracted document element; and a display-control-data generating unit that generates display control data for the document-image data containing a range-of the extracted document element to be displayed and specified order of reading the document element.

A method of displaying a document-image according to still another aspect of the present invention includes acquiring document-image data containing a document with an image size larger than a screen size of a display unit and display control data specifying an order of reading the document and a range of the document-image data to be displayed; controlling, when displaying the document-image data, a display of specified range by moving a display area on the screen based on specified order; and determining whether a width of the range in a line direction in acquired document-image data is wider than a width of the screen. When it is determined that the width of the range is narrower than the width of the screen, the controlling includes moving the display area in a direction perpendicular to the line direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a PDA and a document-image processing server according to a first embodiment;

FIG. 2 is an example of document image data acquired by the document-image processing server according to the first embodiment;

FIG. 3 is a schematic representing areas of document elements specified by a document-element extracting unit of the document-image processing server according to the first embodiment;

FIG. 4 is a schematic representing areas of lines specified by the document-element extracting unit as a modification of the first embodiment;

FIG. 5 is an example of display control data generated by a display-control-data generating unit according to the first embodiment;

FIG. 6 is a schematic of a structure of a tag included in the display control data;

FIG. 7 is an example of display control data when one document has a plurality of pages;

FIG. 8 is a schematic representing a direction of movement of a display area displayed by the control of a display control unit in the PDA according to the first embodiment;

FIG. 9 is a schematic representing a range of a display area displayed by the control of the display control unit of the PDA;

FIG. 10A is a screen example displayed on a display unit of the PDA;

FIG. 10B is a screen example displayed on the display unit of the PDA following the screen of FIG. 10A;

FIG. 11 is a schematic representing a direction of movement of a display area controlled by the display control unit in the PDA when the width of a column in the line direction is wider than a screen width of the display unit;

FIG. 12 is a schematic representing a direction of movement of a display area controlled by the display control unit in the PDA when there are a plurality of columns in the display unit in which the width of the columns in the line direction is wider than the screen width;

FIG. 13 is a schematic representing a direction of movement of a display area controlled by the display control unit in the PDA when there are a plurality of columns of which line direction is the vertical direction;

FIG. 14 is a flowchart of a procedure of process from acquisition of document image data to transmission of document image data attached with display control data to the PDA in the document-image processing server;

FIG. 15 is a flowchart of a procedure of process from reception of the document image data attached with display control data to display of the document image data in the PDA;

FIG. 16 is a schematic of an example of document image data with a complicated structure including columns of which line direction is a vertical direction, including columns of which line direction is a horizontal direction, and including photographic images;

FIG. 17 is a schematic representing a reading order of the columns and the images, in the document image data of FIG. 16, specified by a reading-order specifying unit of the document-image processing server according to a first modification of the first embodiment;

FIG. 18 is a screen example when an icon is displayed for each column on the display unit of the PDA according to a second modification of the first embodiment;

FIG. 19 is a block diagram of a PDA and a document-image processing server according to a second embodiment;

FIG. 20 is a schematic representing a relationship between screen size of the PDA and a range to be displayed of document image data according to the second embodiment;

FIG. 21 is a screen example of displaying column 1 of FIG. 20 having been enlarged, on the display unit of the PDA according to the second embodiment;

FIG. 22 is a schematic representing ranges of display areas displayed by the display control unit of the PDA;

FIG. 23 is a schematic representing ranges of display areas displayed by the display control unit of the PDA according to a modification of the second embodiment; and

FIG. 24 is a diagram of a hardware configuration of the PDA.

### DETAILED DESCRIPTION OF THE PREFERRED EMBODIMENTS

Exemplary embodiments of the present invention are explained in detail below with reference to the accompanying drawings. The embodiments as explained below indicate a case where the document-image display apparatus is applied to a PDA, but it is not limited to the PDA, and hence it may be applied to any electronic equipment, for example, easy-to-carry electronic devices such as mobile, phones.

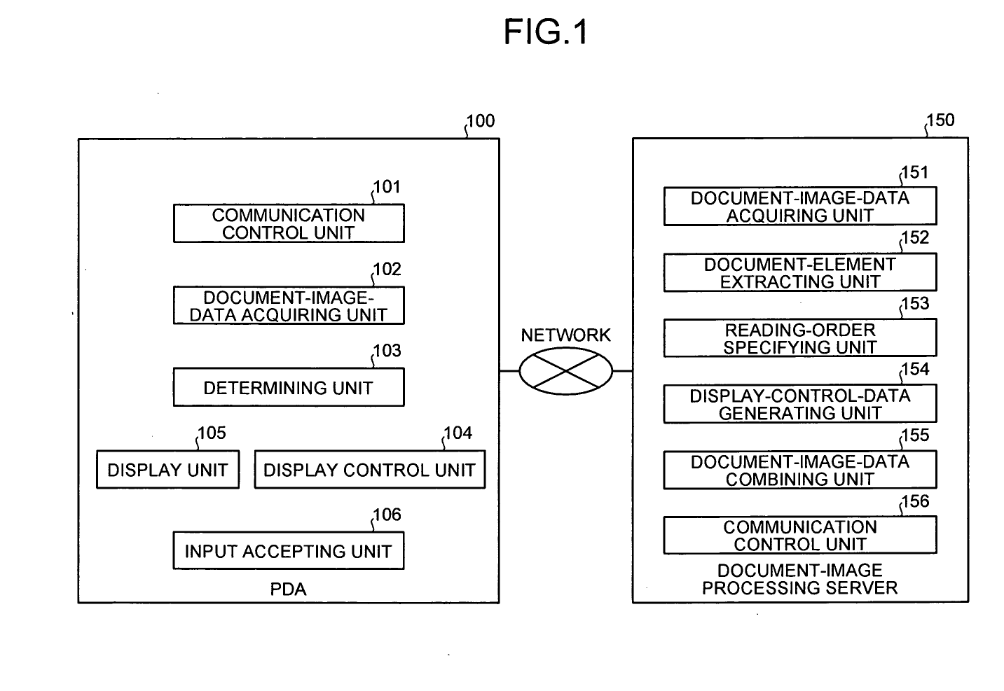

FIG. 1 is a block diagram of a PDA 100 and a document-image processing server 150 according to a first embodiment of the present invention. The PDA 100 and the document-image processing server 150 are connected to each other through a network. The network may be any network such as a public line network and a Local Area Network (LAN). When the PDA 100 is connected to the document-image processing server 150, the connection may be wired or wireless.

The document-image processing server 150 includes a document-image-data acquiring unit 151, a document-element extracting unit 152, a reading-order specifying unit 153, a display-control-data generating unit 154, a document-image-data combining unit 155, and a communication control unit 156. The document-image processing server 150 performs processes from acquisition of document image data in which document is displayed to transmission of the document image data adding thereto display control data used for displaying the document image data, to the PDA 100.

The electronic device, to which the document-image processing server 150 transmits the document image data with the display control data added thereto, is not limited to the PDA 100, and hence it may be any electronic device such as a mobile phone capable of displaying image data.

The document-image-data acquiring unit 151 acquires document image data to be displayed on the PDA 100 or the like. A unit of acquiring the document image data may be any unit that reads data from a paper document using a scanner, or any unit that acquires document image data previously stored in a Hard Disk Drive (HDD) (not shown).

The document image data indicates image data described in a document, and includes image data obtained by reading a paper document with the document described thereon by a scanner or the like, or image data converted from document data.

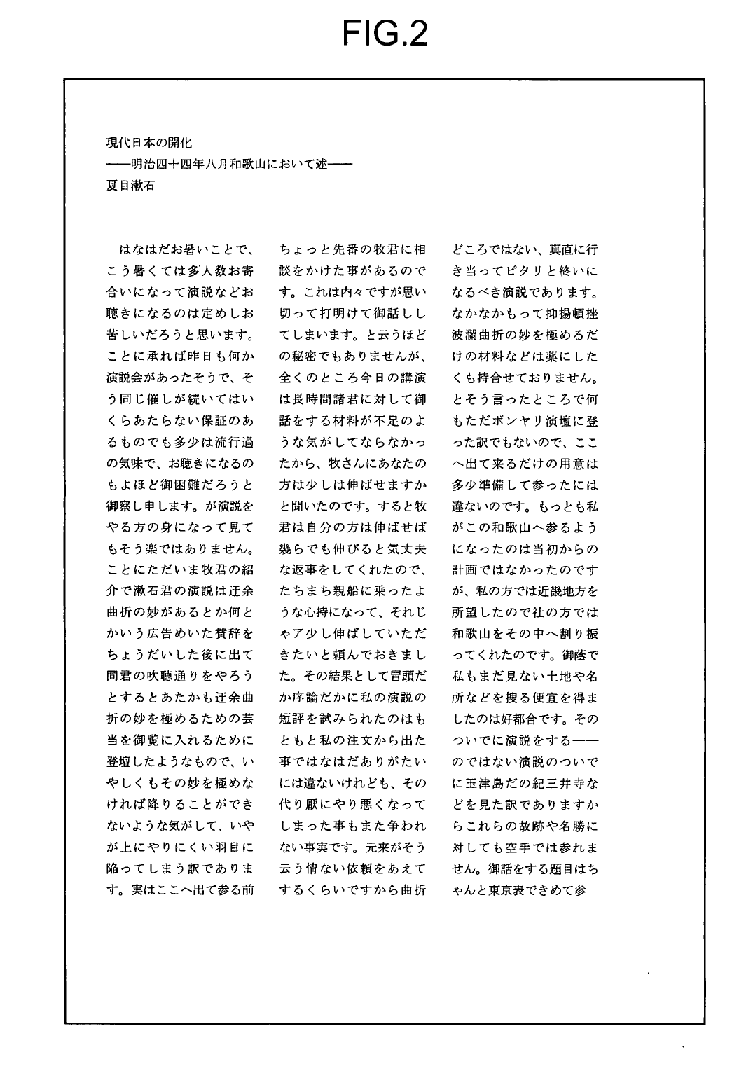

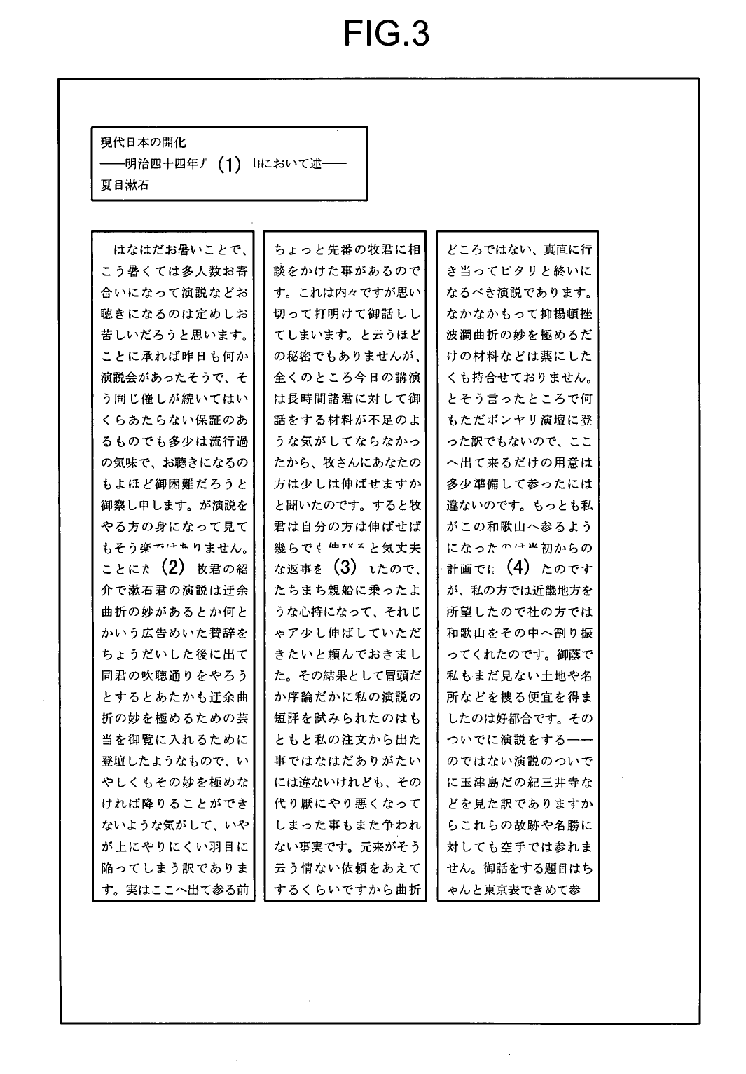

FIG. 2 is an example of document image data acquired by the document-image processing server 150. In the first embodiment, the case where the document image data is an object to be processed is explained. The document image data is structured as a text containing a title and lateral three columns, which respectively correspond to title (1), and columns (2), (3), and (4) shown in FIG. 3.

Referring back to FIG. 1, the document-element extracting unit 152 extracts each document element contained in the document image data. An area can be specified for each document element using the extracted document element. In the first embodiment, the document element is determined as a column. The document-element extracting unit 152 specifies an area of a column contained in the document image data. Furthermore, the document-element extracting unit 152 may extract a graphic or a photographic image contained in the document, as a document element.

As a method of specifying an area of the column by the document-element extracting unit 152, any method such as a method described in Japanese Patent, Application Laid-Open No. H05-233873 may be used. In the method described in the Patent Application, a standard character size is determined, and blocks obtained by dividing the image data using the standard character size are classified into a graphic block and a text block, and text blocks are integrated to extract a line block. And extracted line blocks are further integrated to extract an area for each column. The document-element extracting unit 152 according to the first embodiment specifies an area range for each column and graphic (including photographic images) by using the method, and specifies a line direction for each column from the extracted line blocks.

FIG. 3 is a schematic representing areas of document elements specified by the document-element extracting unit 152. In the areas for each document element shown in FIG. 3, columns are extracted as the document element. These columns are set as ranges to be displayed.

However, the document element to be extracted is not limited to the column, and hence a character or a line may be the document element. As a modification of the first embodiment, a case where a line is extracted as the document element is explained below.

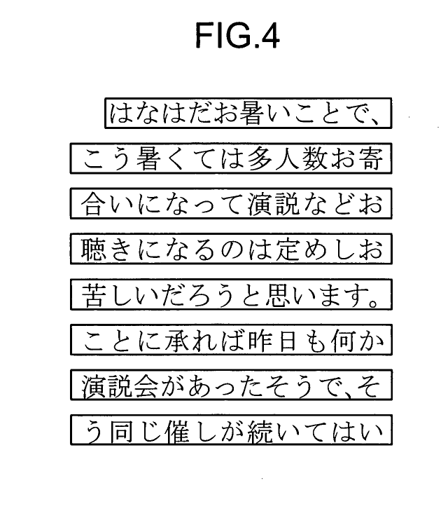

FIG. 4 is a schematic representing areas of lines specified by the document-element extracting unit 152, as a modification of the first embodiment. In this modification, an area for each line as shown in FIG. 4 is set as an object to be displayed, and the order of reading lines is set by the reading-order specifying unit 153. The PDA 100 explained later controls the lines so as to be displayed in their set order. Any one of these technologies may be used irrespective of known technologies.

Referring back to the first embodiment, the reading-order specifying unit 153 specifies the order of reading the extracted columns. As a method of specifying the order of reading them, any method may be used, and, for example, a method described in Japanese Patent Application Laid-Open No. H07-192084 may also be used. By using the method described in Japanese Patent Application Laid-Open No. H07-192084, it is possible to specify whether the area of each document element indicates a title or simply indicates a column. Therefore, the reading-order specifying unit 153 according to the first embodiment specifies the reading order of document elements and specifies whether the area of each document element indicates a title or a column, by using the method.

The display-control-data generating unit 154 generates display control data according to the result of extraction by the document-element extracting unit 152 and the result of specification by the reading-order specifying unit 153. In the first embodiment, the display-control-data generating unit 154 generates display control data that includes an area and a line direction for each column extracted by the document-element extracting unit 152, a reading order of a column specified by the reading-order specifying unit 153, and also includes information as to whether each area is a column or a title.

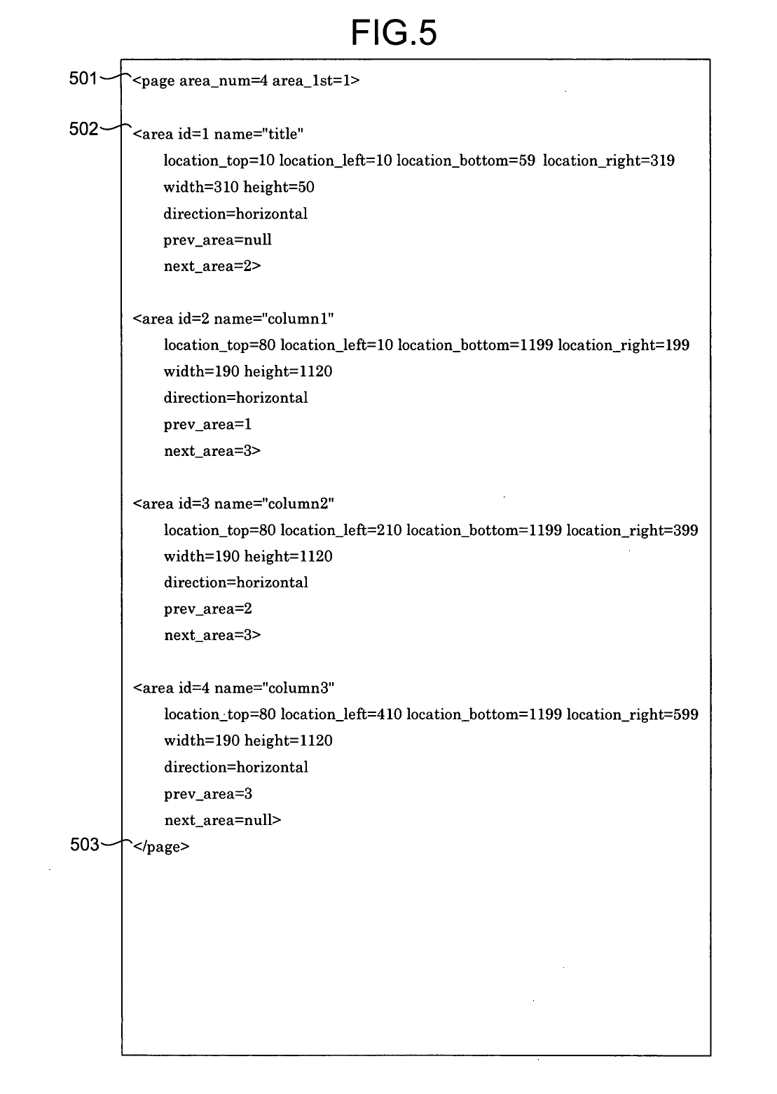

FIG. 5 is an example of the display control data generated by the display-control-data generating unit 154. In the display control data, the information is defined in a text format using tags. Note that the display control data is the display control data for the document image data shown in FIG. 2. Before explaining the details of the display-control data shown in FIG. 5, the tag of the display control data is explained first.

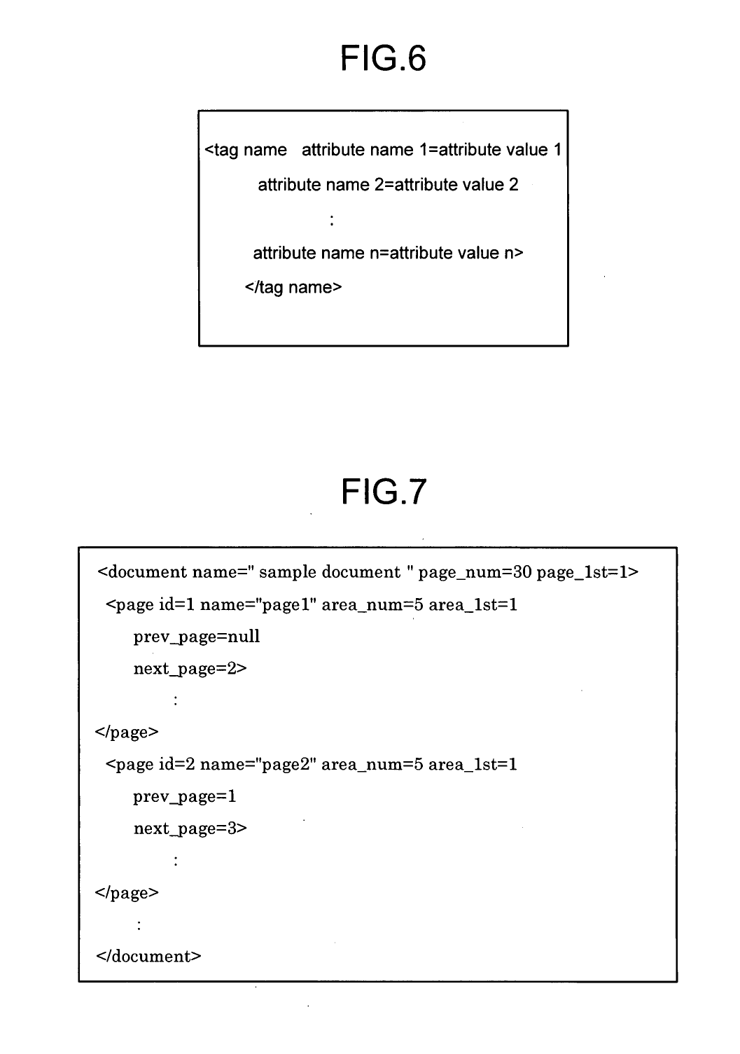

FIG. 6 is a schematic of a structure of the tag included in the display control data. A tag name and an attribute corresponding to a tag can be set in the tag. A tag name which can be set includes ‘document’, ‘page’, ‘area’, and so on. If the tag name is ‘document’, the relevant tag corresponds to one document. If the tag name is ‘page’, the relevant tag corresponds to one page, and if the tag name is ‘area’, the relevant tag corresponds to one area.

When an attribute of a tag is to be set, an attribute name and a parameter of the attribute are described. Moreover, any attribute may be set in a tag. An example of an attribute name used in the embodiments includes ‘area_num’, ‘area_1st’, ‘name’, ‘location_xxx’, ‘width’, ‘height’, ‘direction’, ‘prev_xxx’, and ‘next_xxx’.

The ‘area_num’ represents the number of areas contained in a document element corresponding to a relevant tag. The ‘area_1st’ represents ID indicating a first area to be read of areas contained in the document element. The ‘name’ represents a name of the document element. The ‘location_xxx’ represents coordinates indicating end points of an area of the document element. The ‘width’ represents a width of the area of the document element, and the ‘height’ represents a height of the area of the document element. The ‘direction’ represents a line direction in the document element. The ‘prev_xxx’ represents ID indicating a previous document element in the reading order. The ‘next_xxx’ represents ID indicating a next document element in the reading order. Display control data is generated by using these tags and attributes.

Referring back to FIG. 5, a <page> tag 501 indicates an outline of a page. At first, ‘area_num=4’ indicates four areas within the page, and ‘area_{—}1st=1’ indicates that id as a first area to be read is 1. Then, a </page> tag 503 indicates an end of information for the page.

A <area> tag 502 indicates detailed information for a corresponding area. At first, ‘id=1’ indicates that ID is 1, ‘name=“title”’ indicates that an area name is “title”. Further, ‘location_top=10 location_left=10 location_bottom=59 location_right=319’ indicates a range of an area by upper left coordinates (10, 10)-lower right coordinates (319, 59). Also in the tag 502, ‘width=310’ indicates that the width is 310, and ‘height=50’ indicates that the height is 50. If either information for the under right coordinates or information for the width and the height is set, the range of the area can be identified, and hence, the other one of the two pieces of information may be omitted.

Furthermore, ‘direction=horizontal’ indicates that the line direction is horizontal. The attribute ‘prev_area=null’ indicates that there is no previous area of the area in the reading order, and ‘next_area=2’ indicates that ID of the area as the next one in the reading order is 2. For example, when ‘next_area=2’ is changed to ‘next_area=3’, the next area of the area having id=1 in the reading order is changed to the area of id=3. In other words, the link in the reading order is defined by the ‘prev_area’ and ‘next_area’, and by changing the link, the reading order can be changed.

It is also possible to define that the area is text in the <area> tag, although the explanation is omitted in FIG. 5. In this case, ‘type=“text”’ as an attribute is simply specified in the tag. To identify a type of the area, by specifying an attribute such as ‘figure’ and ‘photo’ in addition to ‘text’, the area can be defined as a graph or a photograph. This allows the PDA 100 to specify the type for each area. The type is information extracted by the document-element extracting unit 152.

When the area is a graph or a photograph, the document may often include description therefor. In this case, the display control data can store therein an association between the area of the graph or of the photograph and the location of its description in the document. For example, it may be considered that a coordinate area of the location of the description in the document is kept in the tag indicating the graph or the photograph. This enables to identify the graph or the photograph and the location of the description associated with it in the PDA 100 that loads the display control data.

The information described in the display control data as shown in FIG. 5 is not limited to only one page. FIG. 7 is an example of display control data when one document has a plurality of pages. It can be recognized that a plurality of <page> tags are described in a <document> tag as shown in FIG. 7. It is also recognized by attributes defined in the <document> tag that a document name is “sample document”, the number of pages are 30 pages, and the ID of an initial page in the reading order is 1. The attributes defined in the <page> tag and the tag are the same as these explained with reference to FIG. 5, and explanation thereof is therefore omitted.

The PDA 100 can identify a range to be displayed on a screen thereof from the coordinates of an area of a document element and the size of the area based on the display control data generated by the document-image processing server 150. The PDA 100 can determine a direction of movement of a display area displayed on the screen based on a line direction of each document element in the document image data and an area of the document element therein.

The display-control-data generating unit 154 may embed a standard character size determined in the document-element extracting unit 152, in the display control data. When it is embedded therein, the PDA 100, explained later, can easily determine whether the user can read a character displayed on the screen based on the standard character size.

Referring back to FIG. 1, the document-image-data combining unit 155 combines generated display control data with document image data. The combined data is determined as document image data attached with the display control data. The attachment of the display control data to the document image data allows easy handling of the display control data.

The communication control unit 156 transmits the document image data with the generated display control data to the PDA 100. The communication control unit 156 also receives document image data for which display control data is generated.

As shown in FIG. 1, the PDA 100 includes a communication control unit 101, a document-image-data acquiring unit 102, a determining unit 103, a display control unit 104, a display unit 105, and an input receiving unit 106. The PDA 100 controls the display of a range to be displayed of the document image data on the screen of the display unit 105 according to the reading order of the document image data.

The display unit 105 may be configured in any manner if the display unit 105 has a display screen, and in the embodiment, it is a liquid-crystal touch panel included in the PDA 100.

The input receiving unit 106 receives an input from the user. The display control unit 104, explained later, controls the display of the screen according to the input from the input receiving unit 106. Any device may be used as an input device, which is a means through which the input receiving unit 106 receives an input. A liquid-crystal touch panel capable of detecting a direction key provided in the PDA 100 and also detecting a touch may be used as the input device. With the input receiving unit 106, the area to be displayed of the document image data can be displayed according to a request through an operation of the user.

If the document image data is sequentially displayed according to the contents of the document, the input receiving unit 106 generates an instruction to one-dimensionally (forward, backward) move the screen. In other words, the operation of the PDA 100 according to the first embodiment becomes easier as compared with an instruction to two-dimensionally move document image data based on the conventional technology.

The communication control unit 101 controls communications with an electronic device such as the document-image processing server 150 connected thereto via a network, to transmit/receive information.

The document-image-data acquiring unit 102 acquires document image data with display control data from the information received by the communication control unit 101.

When a range such as a range of a column to be displayed included in the acquired document image data is displayed, the determining unit 103 determines whether the width of the range to be displayed, such as a column or a title, in its line direction is wider than the screen width of the display unit 105, from the display control data attached to the document image data. The range to be displayed may include a range of an image area such as a photograph or a graph in addition to the column or the title.

The display control unit 104 controls the display so as to move a display area of the document image data on the screen of the display unit 105 based on the display control data and the determination result of the determining unit 103. A case where the determining unit 103 determines that the width of the column to be displayed in a direction of its reading order is narrower than the screen width of the display unit 105 is explained first.

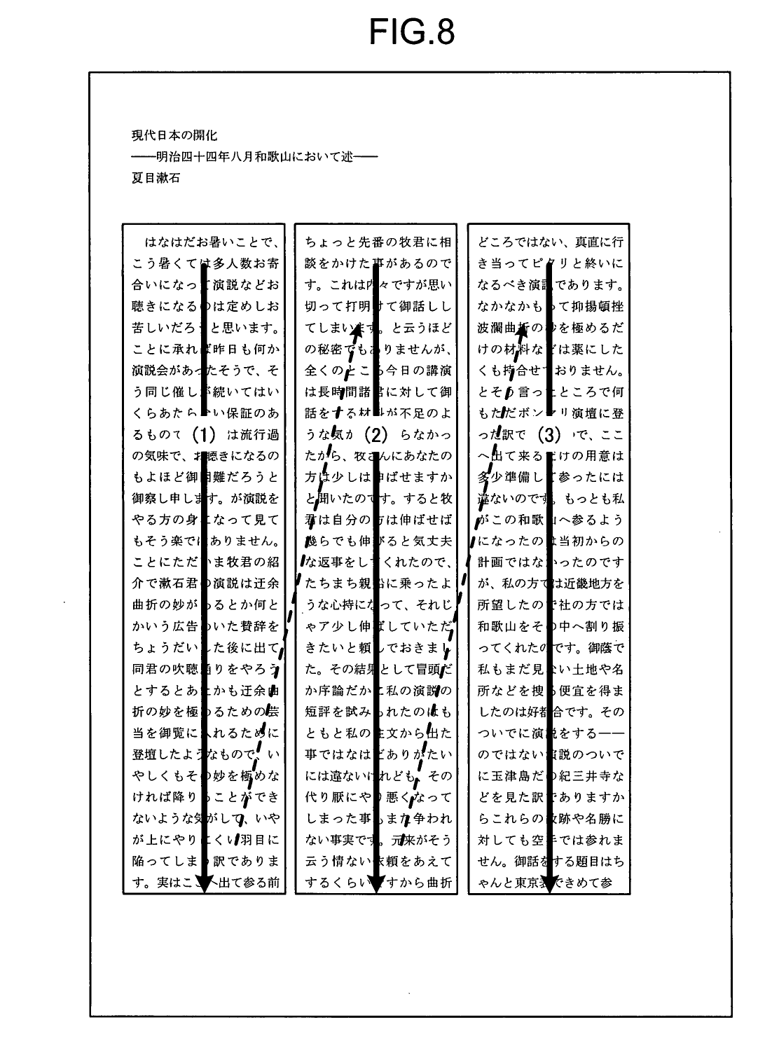

FIG. 8 is a schematic representing a direction of movement of a display area displayed by the control of the display control unit 104. The process performed during determination of a movement direction is explained below. The display control unit 104 sets the order of displaying columns according to the display control data. In the example shown in FIG. 8, the display control unit 104 sets the reading order of the columns to an ascending order of numbers in respective parentheses such as column (1), column (2), and column (3).

The line direction of each column is set as an attribute in the display control data. For example, when ‘direction=horizontal’ is set in the display control data as shown in the <area> tag 502 of FIG. 5, the display control unit 104 can determine that the line direction is horizontal. Therefore, if the width of the horizontal direction of the column is within the screen width of the display unit 105, the display control unit 104 controls the display area so as to move in its downward direction, i.e., the direction indicated by a solid arrow line of FIG. 8. Thereafter, the display control unit 104 controls the display so that after the end of a column is displayed, the next column is displayed from the beginning thereof.

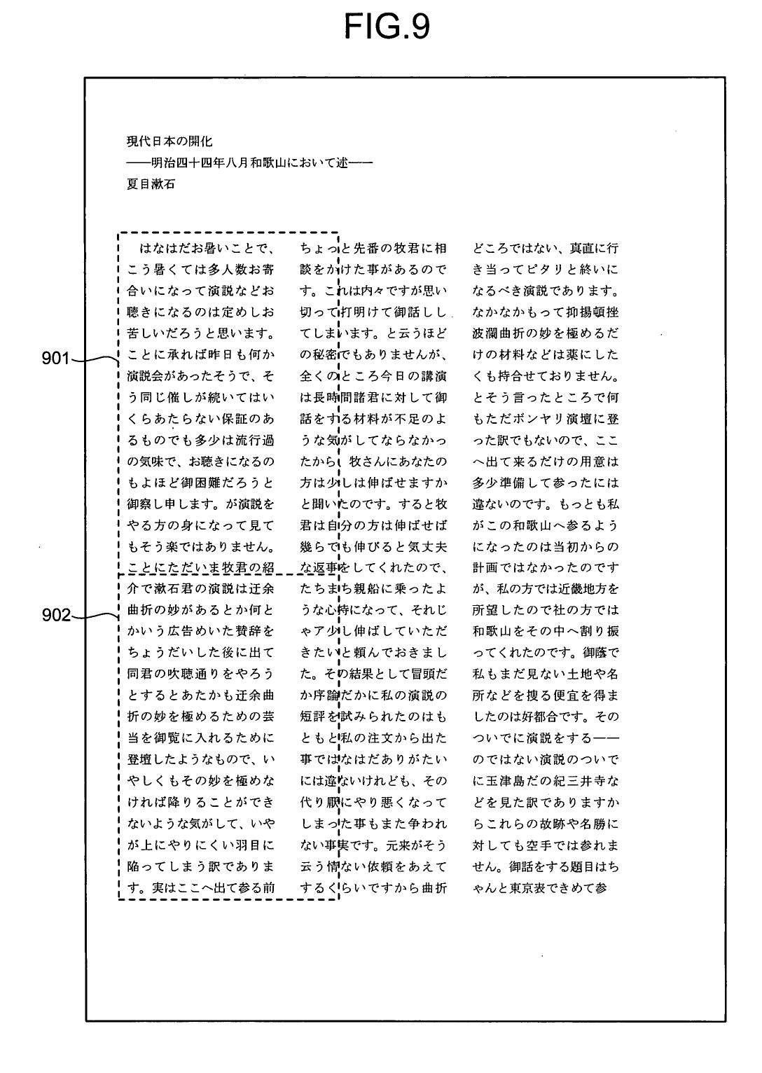

FIG. 9 is a schematic representing a range of a display area displayed by the control of the display control unit 104. An area 901 indicates a first area in the column (1) displayed by the display control unit 104. When the input receiving unit 106 receives an input indicating forward movement, the display control unit 104 controls the display area to move from the area 901 to an area 902 according to the input. After the display area moves to the area 902, the display control unit 104 controls the display area so as to display the next column (2). With these controls, the user can view the document contained in the columns without interruption.

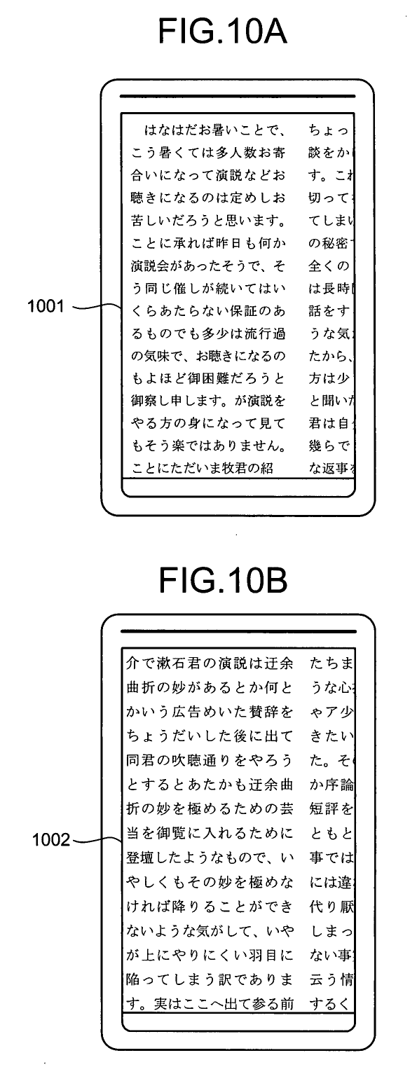

FIG. 10A is a screen example displayed on the display unit 105. As shown in a screen 1001, it is recognized that the area 901 shown in FIG. 9 is displayed thereon.

FIG. 10B is a screen example displayed on the display unit 105 next to the screen example of FIG. 10A. As shown in a screen 1002, it is recognized that the area 902 shown in FIG. 9 is displayed thereon. Display control by the display control unit 104 enables the display of the screen shown in FIG. 10B from the screen shown in FIG. 10A. More specifically, the display control is performed thereby when the input receiving unit 106 receives the input indicating the forward movement.

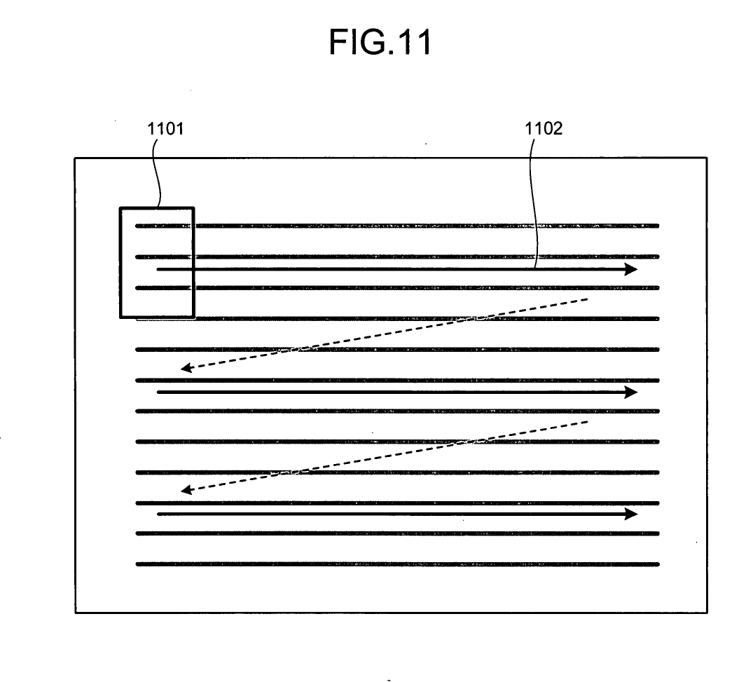

FIG. 11 is a schematic representing a direction of movement of a display area controlled by the display control unit 104 when the width of the column in the line direction is wider than the screen width of the display unit 105. An area 1101 of FIG. 11 is a display area initially displayed on the display unit 105. With the input indicating the forward movement, to the input receiving unit 106, the display control unit 104 controls the display area of the display unit 105 to be displayed to the right end of the column according to a solid arrow line 1102. Thereafter, the display control unit 104 controls the display area to be displayed from the left end of the column. At this time, the display control unit 104 controls the display area so as to move down one line. The display control unit 104 controls the display area in the above manner, and this allows the user to view all the contents of the columns without interruption simply by entering the input indicating the forward movement into the input device.

As for the column shown in FIG. 11, when displaying the column to its right end and displaying again the left end of the column, the display control unit 104 may display the column without moving down one line, although this is different from the first embodiment. In this case, the display control unit 104 repeats this process by the number of lines contained in the screen. The display control unit 104 repeats the process by the number of lines, and moves down one screen to display the left end of the column. The display control unit 104 performs the processes to enable prevention of the display of the next screen before the user finishes reading the text from the second line onward displayed on the screen.

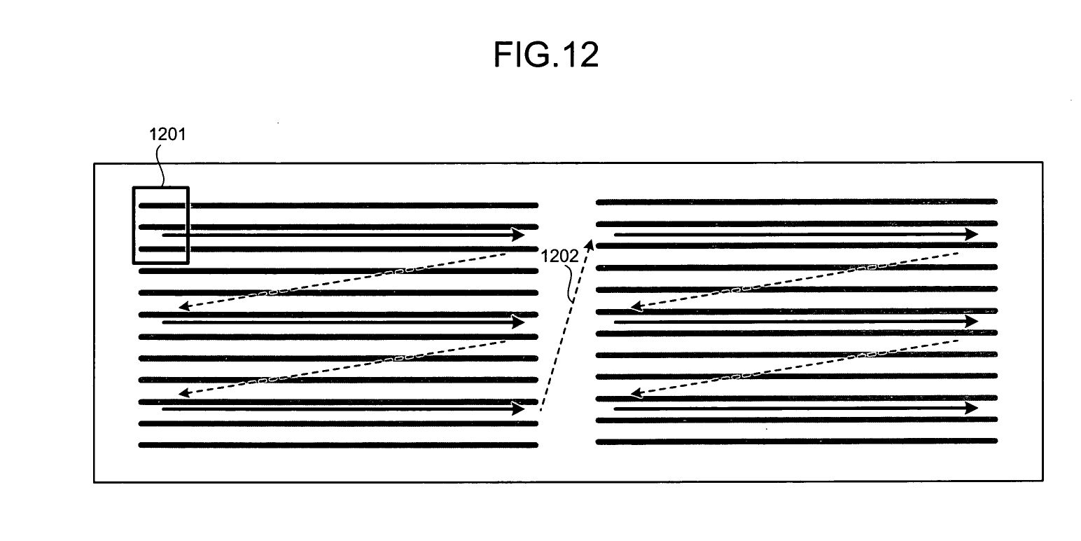

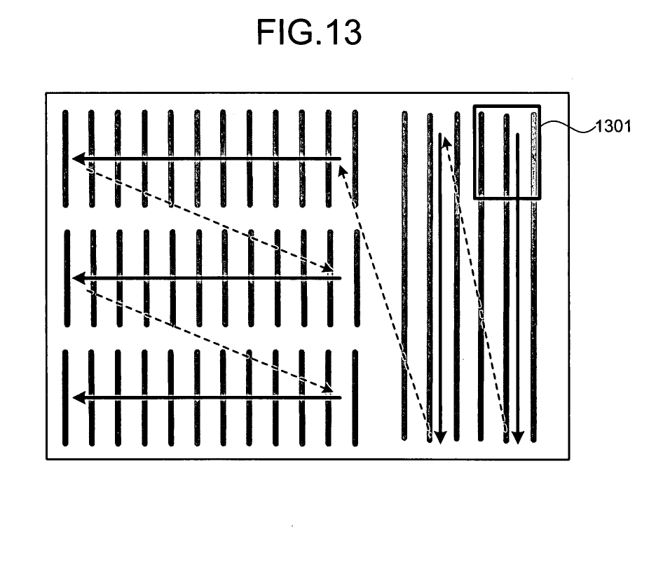

FIG. 12 is a schematic representing a direction of movement of a display area controlled by the display control unit 104 when the display unit 105 has a plurality of columns of which width in the line direction is wider than the screen width. An area 1201 of FIG. 12 is a display area initially displayed on the display unit 105. The display control for each column by the display control unit 104 is the same as that of FIG. 11. The reading order of the columns is defined in the display control data. Therefore, to display a next column after the display of a first column is finished, the display control unit 104 can control the display area so as to move in the direction indicated by a dotted arrow line 1202 of FIG. 12.

FIG. 13 is a schematic representing a direction of movement of a display area controlled by the display control unit 104 when there are a plurality of columns of which line direction is the vertical direction. An area 1301 of FIG. 13 is a display area initially displayed on the display unit 105. The area 1301 can be identified from the reading order and the line direction of the column contained in the display control data. Based on the result of determination by the determining unit 103 whether the width of the column in the line direction is wider than the screen width of the display unit 105, the display control unit 104 can determine the direction to which the display area is moved in each column in the same manner as the process when the line direction is the horizontal direction. The process thereafter is the same as that when the line direction is the horizontal direction, and explanation thereof is therefore omitted.

To enable such control in the PDA 100, a dedicated program (document-image display program) is assumed to be previously installed therein. Because the document-image display program has the configuration as above, this allows the control to be performed in the PDA 100. The program to be installed is not limited to the dedicated program, and, for example, Plug-in of a Web browser previously prepared in the PDA 100 may be used.

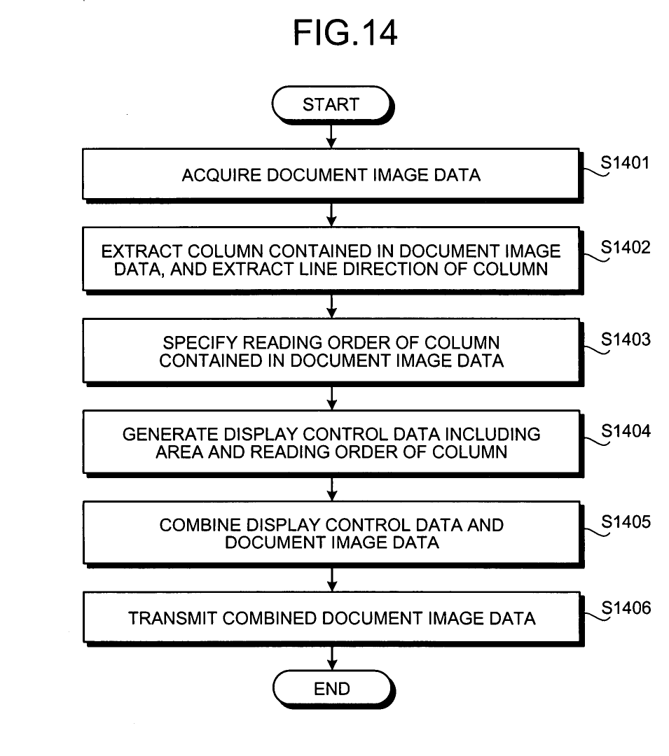

The process from acquisition of document image data to transmission of the document image data attached with the display control data to the PDA 100 in the document-image processing server 150 according to the first embodiment configured in the above manner is explained below. FIG. 14 is a flowchart of a procedure of the process in the document-image processing server 150 according to the first embodiment.

First, the document-image-data acquiring unit 151 acquires document image data to be displayed on the PDA 100 or the like (step S1401).

Next, the document-element extracting unit 152 extracts a column, a graphic (including a photographic image), and the like contained in the acquired document image data as a document element (step S1402). The document-element extracting unit 152 also extracts a line direction for each extracted column.

The reading-order specifying unit 153 specifies the reading order of the columns contained in the document image data (step S1403). The columns and the title as the document elements are discriminated through the process by the reading-order specifying unit 153.

The display-control-data generating unit 154 generates display control data from the information acquired through the processes by the document-element extracting unit 152 and the reading-order specifying unit 153 (step S1404). For example, the display-control-data generating unit 154 includes the area and the line direction of the document element extracted by the document-element extracting unit 152, the reading order in document elements specified by the reading-order specifying unit 153, and the type of the document element, in the display control data.

The document-image-data combining unit 155 combines the generated display control data with document image data (step S1405). A combining method may be any method, and may be a method of including display control data in, for example, a header area of a document image data.

The communication control unit 156 transmits the document image data attached with the display control data to the PDA 100 (step S1406).

The process procedure enables the PDA 100 to acquire the document image data and the display control data. It is noted that the process procedure indicates only an example of the process procedure from the acquisition of the document image data to the transmission of the document image data attached with the display control data to the PDA 100 according to the first embodiment. Therefore, the present invention is not limited to the process procedure.

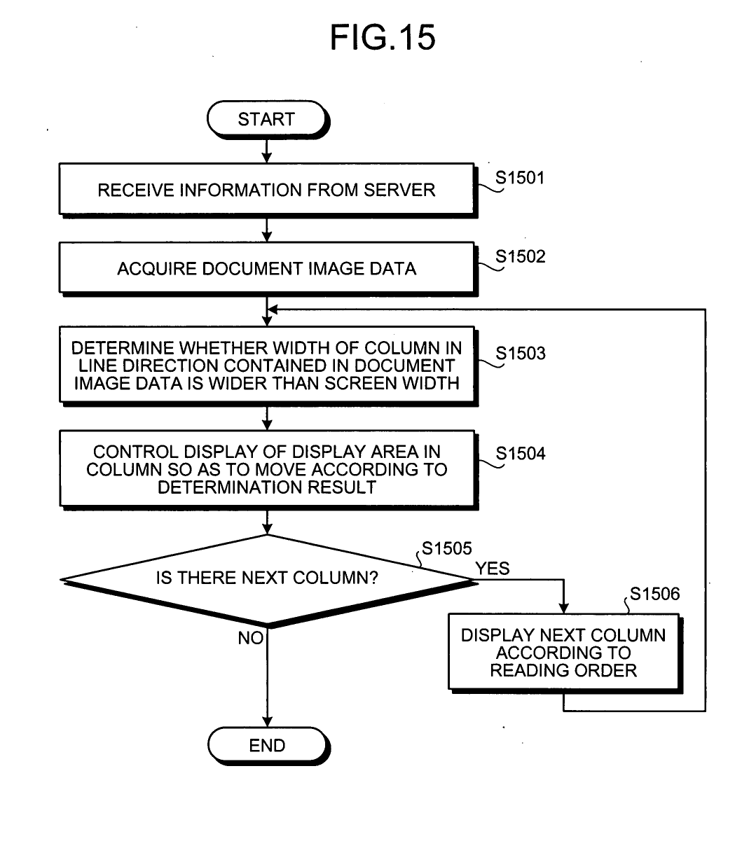

The process from reception of the document image data attached with the display control data by the PDA 100 to display control of the document image data according to the first embodiment configured in the above manner is explained below. FIG. 15 is a flowchart of a procedure of the process in the PDA 100 according to the first embodiment.

First, the communication control unit 101 of the PDA 100 controls communications with the document-image processing server 150, to receive information therefrom (step S1501).

Next, the document-image-data acquiring unit 102 acquires the document image data attached with the display control data from the received information (step S1502).

The determining unit 103 determines whether the width of the column contained in the document image data in the line direction is wider than the screen width of the display unit 105 in the PDA 100 (step S1503). If the determination is executed after the document image data is acquired, the first column in the reading order of the document image data is set as an object to be determined. The reading order of the column, the line direction thereof, and the width thereof in the line direction are acquired from the display control data.

The display control unit 104 controls the display area of the document image data so as to move according to the determination result of the determining unit. 103 and the range (range of a column) to be displayed contained in the display control data (step S1504). The process of changing the display area is performed when the input receiving unit 106 receives an input indicating forward movement or backward movement from the input device.

The display control unit 104 determines whether there is a next column from the display control data after control is performed so as to display the column to its end (step S1505).

When it is determined that there is the next column (YES at step S1505), the display control unit 104 displays the first part of the next column as a range to be displayed in the reading order contained in the display control data (step S1506). The determining unit 103 again performs the process based on the comparison between the width of the displayed column in the line direction and the screen width (step S1503).

When it is determined that there is no next column (NO at step S1505), the display control unit 104 ends the display control without moving the display area even if the input receiving unit 106 receives the input indicating the forward movement.

The process procedure allows the user to view all the columns contained in the document image data with easy operation without interruption. It is noted that the process procedure indicates only an example of the process procedure from the reception of the document image data attached with the display control data to the display control of the document image data according to the first embodiment. Therefore, the present invention is not limited to the process procedure.

The display control data is defined by the tag and the attribute in the first embodiment. The tag and the attribute is easily extended, which enables easy handling of attributes and tags which are not explained in the first embodiment or of data exchange which is quite possible to be required in future by users.

The display control unit 104 according to the first embodiment changes the display area displayed on the display unit 105 by switching the screen, but the change is not limited to the change of the screen. Therefore, for example, the process of changing the display area may be performed by scrolling.

In the first embodiment, the document-image processing server 150 generates the display control data, and the PDA 100 controls the display of the document image data based on the display control data. However, the generation and use of the display control data are not necessarily performed by discrete electronic devices, and hence, one electronic device may generate and use the display control data.

The display control data describes an attribute of a display targeted area of the document image data. The PDA 100 independently determines a movement direction based on the attribute contained in the display control data and controls the display. However, the operation is not limited to the mechanism. For example, the movement direction or the like is previously described in the display control data, and the PDA may control the display according to the description.

The first embodiment does not limit to combination of the document image data and the display control data, and both of them may be handled as separate files. As a modification different from the first embodiment, the document image data and the display control data are provided as separate files. In this case, in the document image data and the display control data, their file names with extensions are caused to match each other to define a correspondence between the data. The document-image processing server 150 transmits document image data and display control data corresponding to the document image data to the PDA 100. When loading the document image data, the PDA 100 also loads the corresponding display control data. This allows the PDA 100 to control the display of the document image data according to the display control data.

In the case of the modification, it is considered that the PDA 100 may employ a method of acquiring data other than a method of concurrently receiving the display control data and the document image data from the document-image processing server 150. For example, the PDA 100 acquires document image data by using any unit, and transmits the document image data to the document-image processing server 150 when the user wants to view-the document image data. The document-image processing server 150 generates display control data corresponding to the received document image data and transmits the generated data to the PDA 100. Thereafter, the PDA 100 may display the document image data according to the received display control data.

In the first embodiment, even if an electronic device such as the PDA 100 has a small screen size, displayed document image data larger than the screen size can easily be viewed thereby. When documents contained in document-image data are to be sequentially viewed, the user simply enters a one-dimensional input, thus improving the operability upon viewing the document-image data.

The present invention is not limited to the first embodiment, and therefore, various modifications are possible as shown in the following examples.

In the first embodiment, only the case where the column as a document element of the document-image data is contained therein is explained. And the case where the line direction of the column is either one of the vertical direction and the horizontal direction is explained. However, the document image,data is not limited to these cases.

In a first modification of the first embodiment, document image data containing a column whose line direction is the vertical direction, a column whose line direction is the horizontal direction, and a graphic is explained below.

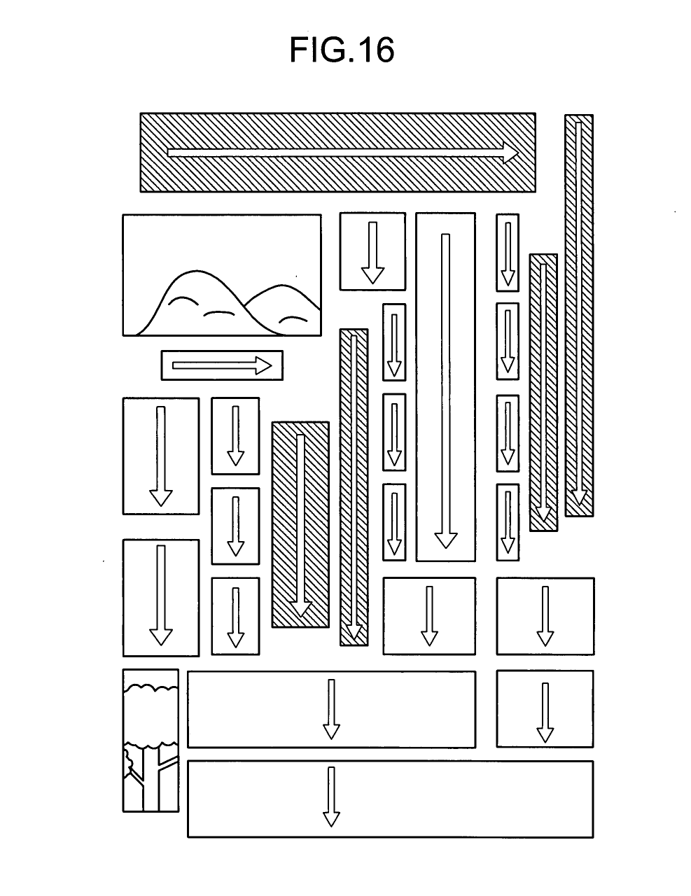

FIG. 16 is an example of document image data with a complicated structure including columns whose line direction is the vertical direction, columns whose line direction is the horizontal direction, and photographic images. The document image data shown in FIG. 16 is obtained by scanning data on a news paper by a scanner.

The lines included in the document image data are omitted to simplify explanation, and only the line directions are indicated by each open arrow. Blocks indicated by the open arrow are set as text areas, but shaded areas of the text areas correspond to the title and subheadings. As shown in FIG. 16, photographic images are also contained therein.

The document-element extracting unit 152 of the document-image processing server 150 extracts a text area and a graphic area, and extracts the line direction for each text area. The reading-order specifying unit 153 specifies the reading order (the order of display) including the text area and the graphic area. The reading-order specifying unit 153 also determines whether a plurality of columns indicate one content or one column indicates one content. The display-control-data generating unit 154 sets a title and the like of each column of the display control data according to the determination result. This setting enables the PDA 100 to determine whether the columns should be read without interruption or one column indicates one content.

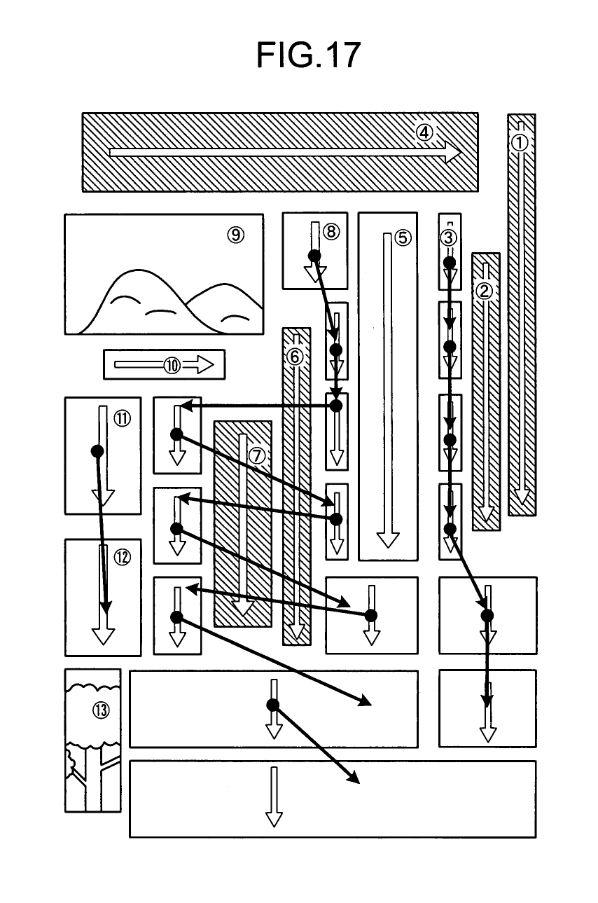

FIG. 17 is a schematic representing the order of reading the columns and the images specified by the reading-order specifying unit 153 for each document image data shown in FIG. 16. The bold arrows each connecting between columns shown in FIG. 17 indicate the order to read the columns without interruption. Each single column without the bold arrow indicates one content. The numbers assigned to the columns indicate the reading order required when the reading-order specifying unit 153 displays the document image data. More specifically, as shown in FIG. 17, the numbers are set in such a manner that numbers 1 and 2 are first assigned to a title and then a next number 3 is assigned to the columns representing the content indicated by the title. The reading order of the photographic images may be set in such a manner that a column representing the content is set first and then a photographic image is set, or may be set in such a manner that a photographic image is set first and then a column describing the photographic image is set. Even if the image data is displayed in the document image data in the above manner, the user can easily view the data.

The columns are displayed in the reading order on the PDA 100 based on the display control data. The line direction of each column can be determined from the display control data, and therefore, even if the document image data has a plurality of line directions, it is possible to control the display suitable for each column.

As shown in the first modification, by generating display-area control data that includes the text areas, the graphics, and the photographic images in the reading order, these data can be viewed in their appropriate order.

In the first embodiment, only the document image data is displayed on the screen of the display unit 105 in the PDA 100. However, any information other than the document image data may be displayed thereon.

In a second modification of the first embodiment, a case where an icon indicating a column is displayed on the screen of the display unit 105 in the PDA 100 is explained below.

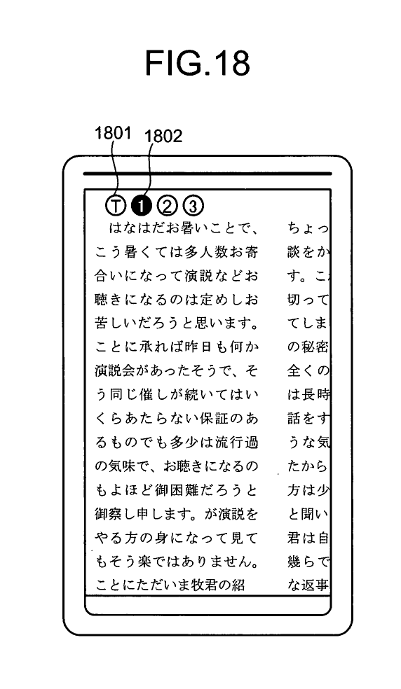

FIG. 18 is a screen example when an icon is displayed for each column on the display unit 105. It is noted that FIG. 18 shows a case where the document image data shown in FIG. 3 is used. More specifically, the one title and the three columns are contained in the document image data. In this case, four icons are displayed as shown in FIG. 18. An icon ‘T’ 1801 indicates the title of document image data, and an icon ‘1’ 1802 indicates a first column. As the icons, a number or an initial to identify a column is displayed based on a name and the like contained in the <area> tag of the display control data. The icon highlighted in color indicates a currently displayed column.

When the input receiving unit 106 receives a selection of the icon, the display control unit 104 controls a column, a title, or a graphic area corresponding to the selected icon to be displayed. This makes easy an operation to move to an interested column.

In the second modification, the icon and the area for the document image data are separately provided, but the icon may also be displayed as a semi-transparent one by being superimposed on the document image data.

The information to be displayed on the screen may be any ones such as thumbnails other than the icons. By displaying a graphic or a photographic image in particular contained in the document image data as the thumbnail, the user can understand the outline of the graphic or the photographic image without displaying the graphic or of the photographic image on the display unit 105 in the PDA 100. A title and a column may be also displayed with thumbnails. By displaying the icons and thumbnails on the screen in the above manner, the user can easily check the area to be displayed contained in the document-image data.

In the first embodiment, the PDA 100 instructs to move through one-dimensional operation (forward, backward) from the input receiving unit 106 upon display control of the document image data. However, the instruction is not limited only by the one-dimensional operation.

In a third modification of the first embodiment, a case where operation keys are further provided to receive an input, in addition to the operation keys through which one-dimensional operation is entered, is explained below.

A newly added operation key in the third modification is used not to control the movement within a column but to control the movement to a next column or the movement to a previous column. With this key, the user can skip the display of a column which the user is not interested in, and this allows improvement of the usability.

Furthermore, an input operation other than the operation may be received. For example, display control data may have information such that an area of a graphic or a photographic image is previously associated with an area containing explanation for the graphic or the photographic image in a column.

When the explanation for the graphic or the photographic image contained in a column is displayed on the display unit 105, the input receiving unit 106 receives an input through a predetermined operation. This may enable the display control unit 104 to control the display of the graphic or the photographic image associated with the displayed explanation according to the display control data.

The input receiving unit 106 according to the third modification can select image data with a predetermined operation, that is, the input receiving unit 106 serves as a selection receiving unit. The predetermined operation includes those such as depression of an area containing explanation for the graphic or the photographic image displayed on the display unit 105, using an input device such as a touch pen, and depression of an operation key for any operation other than the forward and backward movements. With these operations, the user can easily view image data.

When a column is to be displayed and if there is any associated graphic or photographic image, the display control unit 104 may control any operation such as changing a background color of the area in the column.

In the first embodiment, a scaling process is not subjected to the document image data to display the data on the screen of the PDA 100. However, the scaling process may be performed on the document image data so as to obtain the document image data of an appropriate size for the screen of the PDA. In a second embodiment, a case where scaling process is performed when a PDA displays document image data.

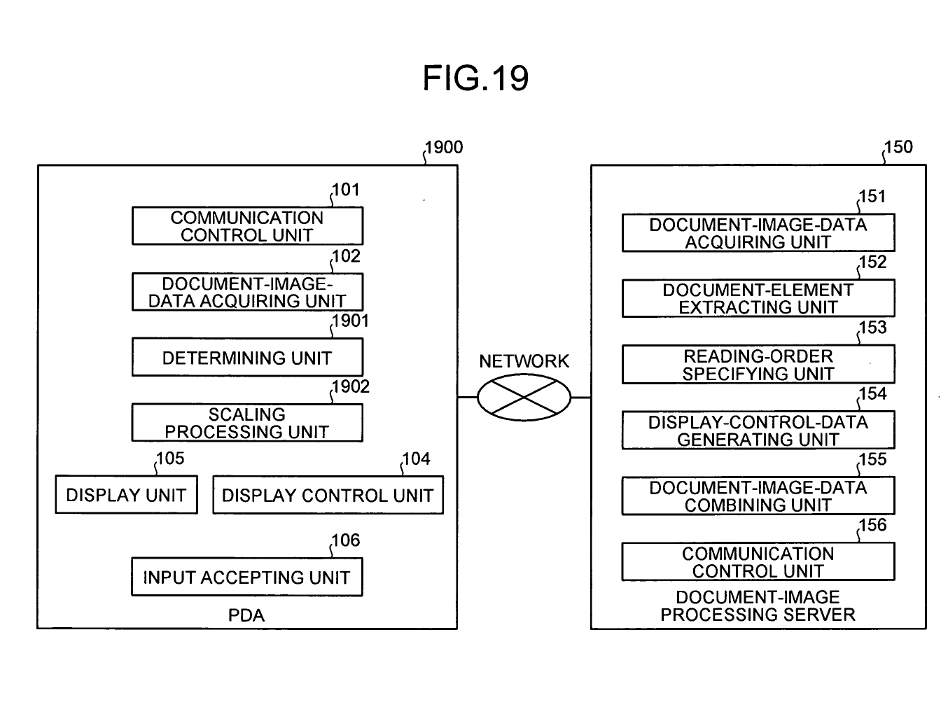

FIG. 19 is a block diagram of a PDA 1900 and the document-image processing server 150 according to the second embodiment of the present invention. The PDA 1900 is different from the PDA 100 according to the first embodiment in that the determining unit 103 is changed to a determining unit 1901 having a different process therefrom and that a scaling processing unit 1902 is added to the PDA 1900. In the following explanation, the same reference numerals are assigned to the same components as these of the first embodiment and explanation thereof is omitted.

The determining unit 1901 determines whether the width of a range to be displayed in the line direction is wider than the screen width of the display unit 105 in the same manner as that of the first embodiment, and determines whether a scaling process is possible.

When it is determined that the width of the range in the line direction is wider than the screen width, the determining unit 1901 extracts a character size being a standard from the range to be displayed. When the range to be displayed is reduced at scaling magnification so that the width in the line direction matches the screen width, the determining unit 1901 determines whether the user can recognize the characters contained in the area on the screen of the display unit 105 based on the extracted character size.

The scaling processing unit 1902 performs a scaling process of enlarging or reducing a range to be displayed contained in document image data at scaling magnification so that the width of the range to be displayed in the line direction matches the screen width. However, when the range is reduced and if the determining unit 1901 determines that the users are unable to recognize characters, then the scaling processing unit 1902 does not perform the scaling process. An enlarging process performed by the scaling processing unit 1902 is explained below.

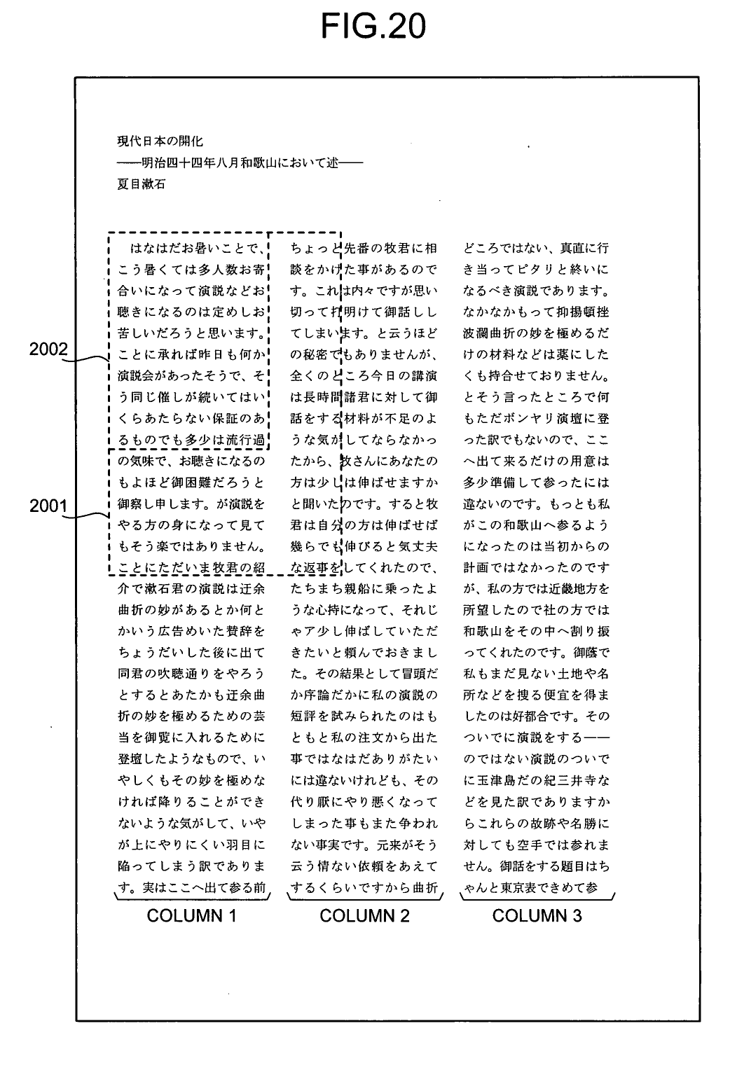

FIG. 20 is a schematic representing a relationship between a screen size of the PDA 1900 and a range to be displayed of the document image data. An area 2001 of FIG. 20 is a screen size of the PDA 1900. More specifically, if the document image data (columns 1 to 3) is displayed on the display unit 105 of the PDA 1900 as it is, part of the column 2 is included therein in addition to the column 1.

Therefore, the scaling processing unit 1902 enlarges the area to be displayed to match the width of the column 1 (the width of the area to be displayed) with the screen width of the display unit 105. An area 2002 matches the screen size of the PDA 1900 through the process performed in the scaling processing unit 1902.

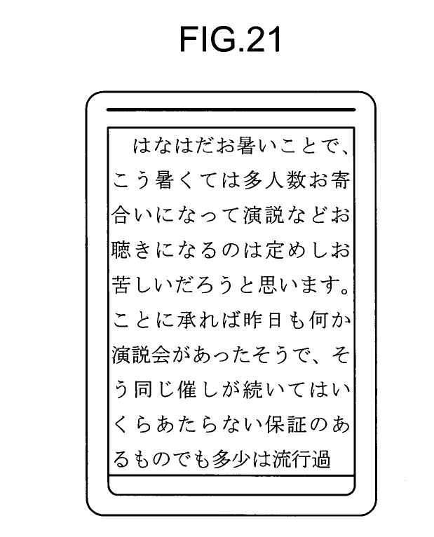

FIG. 21 is a screen example of displaying the column 1 of FIG. 20 on the display unit 105 after being enlarged. The width of the column 1 of FIG. 21 matches the screen width, and this allows improved visibility.

The display control unit 104 controls the display area displayed on the display unit 105 so as to be moved based on the display area after it is enlarged.

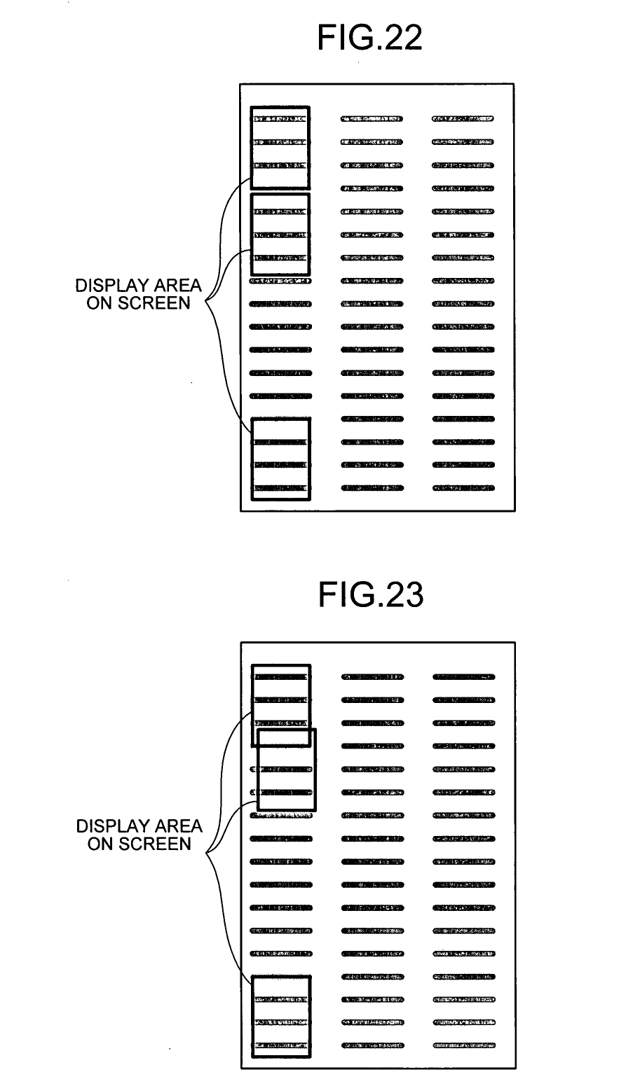

FIG. 22 is a schematic representing ranges of display areas displayed by the display control unit 104. When the input receiving unit 106 receives an input indicating change of the display area, the display control unit 104 controls the movement of the display area so as not to overlap any area.

The process procedure performed by the PDA 1900 according to the second embodiment is the same as that of the first embodiment except the following point different from that of the first embodiment, and explanation thereof is therefore omitted. The point is such that the determining unit 1901 compares the width of a range to be displayed with the screen width of the display unit 105 and determines whether the scaling process is possible, and the scaling processing unit 1902 performs the scaling process on the range to be displayed according to the result.

In the second embodiment, the scaling process is performed at scaling magnification so that the width of an area (column) to be displayed of the document image data matches the screen width of the display unit 105. Thus, the user can easily view the area to be displayed.

The present invention is not limited to the embodiments, and therefore, various modifications as follows are possible.

In the second embodiment, the display control unit 104 controls the movement of the display area so as not to overlap any area. However, the control is not limited to the movement.

FIG. 23 is a schematic representing ranges of display areas controlled by the display control unit 104 according to a modification of the second embodiment. When a range to be displayed is to be moved, the range may be moved so that there is an overlap (overlap width) in a predetermined range in the movement direction. Note that the display area after movement is slightly rightwardly displaced in FIG. 23, but an actual display area is not rightwardly moved.

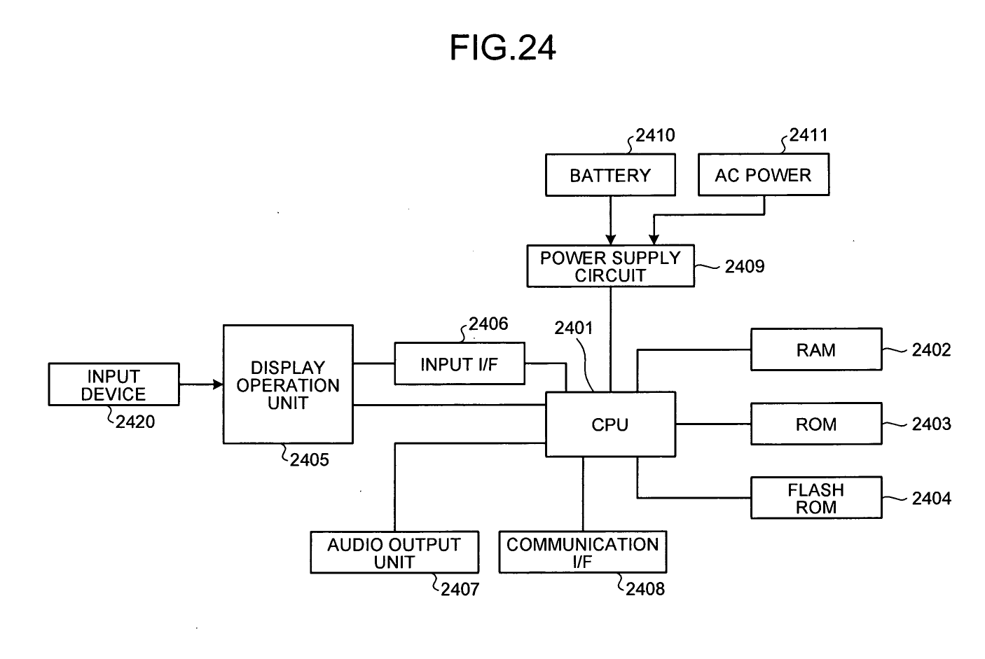

FIG. 24 is a diagram of a hardware configuration of the PDA according to the embodiments. The PDA includes a Central Processing Unit (CPU) 2401 which is a control unit, a Random Access Memory (RAM) 2402, a Read Only Memory (ROM) 2403, a flash ROM 2404 which is an external storage device, a display operation unit 2405 formed with a liquid crystal display capable of operation and display with an input device 2420 such as a touch pen, an input interface (I/F) 2406 for inputting thereto a signal from the display operation unit 2405, an audio output unit 2407 that outputs an audio, a communication I/F 2408 connected to an external device or to a network, and a power supply circuit 2409 enabling connecting a power supply unit such as a battery 2410 or an alternating-current (AC) power 2411 to the hardware. The ROM 2403 or the flash ROM 2404 stores therein a basic program such as operating system (OS) to control the whole of the PDA and application software usable in the PDA.

The document-image processing server according to the embodiments has a hardware configuration using an ordinary computer, and includes a control device such as a CPU, a storage device such as a ROM and a RAM, an external storage device such as a Hard Disk Drive (HDD) and a Compact Disk (CD) drive, a display device such as a display, and an input device such as a keyboard and a mouse.

A document-image display program executed by the PDA or a document-image processing program executed by the document-image processing server according to the embodiments is provided by being recorded in a computer-readable recording medium such as a CD-ROM, a Flexible Disk (FD), a Compact Disk Recordable (CD-R), or a Digital Versatile Disk (DVD) in a file with an installable format or with an executable format.

The document-image display program executed by the PDA or the document-image processing program executed by the document-image processing server may also be provided by being stored in a computer connected to a network such as the Internet, and causing the program to be downloaded through the network. Furthermore, the document-image display program executed by the PDA or the document-image processing program executed by the document-image processing server may also be provided or distributed through a network such as the Internet.

The document-image display program executed by the PDA or the document-image processing program executed by the document-image processing server may also be provided by being previously incorporated in ROM or the like.

The document-image display program executed by the PDA according to the embodiments has a module configuration including the respective units such as the-communication control unit, the document-image-data acquiring unit, the determining unit, the display control unit, the display unit, and the input receiving unit. As actual hardware, the CPU reads the document-image display program from the recording medium and executes the program to load the units into a main storage so that the communication control unit, the document-image-data acquiring unit, the determining unit, the display control unit, the display unit, and the input receiving unit are generated on the main storage.

The document-image processing program executed by the document-image processing server according to the embodiments has a module configuration including the respective units such as the document-image-data acquiring unit, the document-element extracting unit, the reading-order specifying unit, the display-control-data generating unit, the document-image-data combining unit, and the communication control unit. As actual hardware, the CPU reads the document-image processing program from the recording medium and executes the program to load the units into the main storage so that the document-image-data acquiring unit, the document-element extracting unit, the reading-order specifying unit, the display-control-data generating unit, the document-image-data combining unit, and the communication control unit are generated on the main storage.

As described above, according to one aspect of the present invention, when document-image data is to be displayed, control is performed in such a manner that a display area is moved based on the reading order specified by the display control data and a range to be displayed of the document-image data specified by the display control data is displayed. This enables the user to easily view a document contained in the document-image data of image size larger than the screen size of the display unit.

Furthermore, according to anther aspect-of the present invention, display control is performed by moving the display area according to the input received by the input receiving unit. This enables to display the document-image data according to the operation request of the user.

Moreover, according to still anther aspect of the present invention, when the entire line of a range to be displayed of the document-image data is displayed within the screen, display control is performed to move the display area in the vertical direction with respect to the line direction. This enables the user to view a text included in the range to be displayed without interruption.

Furthermore, according to still anther aspect of the present invention, when the entire line of the range to be displayed is not displayed within the screen of the display unit, display control is performed to move the display area in the line direction. This enables the user to view the entire line included in the range to be displayed.

Moreover, according to still anther aspect of the present invention, control is performed in such a manner that the end of a line is displayed and a head of the nest line is displayed. This enables the user to view the text included in the range to be displayed without interruption.

Furthermore, according to still anther aspect of the present invention, control is performed to display each column according to the reading order contained in the display control data. Therefore, even if a plurality of columns are contained in the document-image data, the user can view each column without interruption.

Moreover, according to still anther aspect of the present invention, the user can also easily view the image data contained in the document-image data.

Furthermore, according to still anther aspect of the present invention, control is performed to display the image data by receiving a selection. This enables to display the image data according to the request from the user.

Moreover, according to still anther aspect of the present invention, display control is performed to move the display from an area related to image data to the image data in the document. This enables the user to easily view the image data.

Furthermore, according to still anther aspect of the present invention, an icon representing a range to be displayed is displayed. This enables the user to easily check the range to be displayed contained in the document-image data.

Moreover, according to still anther aspect of the present invention, a thumbnail for image data is displayed. This enables the user to easily check the outline of the image data contained in the document-image data.

Furthermore, according to still anther aspect of the present invention, a range to be displayed of document-image data subjected to the scaling process is displayed. This enables the user to easily view the information.

Moreover, according to still anther aspect of the present invention, the line width or the column width of a range to be displayed of the document-image data matches the screen width of the display unit. This enables the user to easily view the information.

Furthermore, according to still anther aspect of the present invention, the display control data containing an area to be displayed of the document-image data and the reading order is generated. Therefore, the display control data is viewed, and control is performed to display the document-image data. This enables the user to easily view the document-image data larger than the screen size of the display unit.

Moreover, according to still anther aspect of the present invention, display control data containing a line direction is further generated. Therefore, the line direction is further viewed, and control is performed to display the document-image data. This enables the user to easily view the document-image data larger than the screen size of the display unit.

Furthermore, according to still anther aspect of the present invention, a recording medium stores therein the document-image display program. By loading the document-image display program stored therein into a computer, the computer is caused to execute the program.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for displaying a document-image, comprising:
a display unit that displays an image on a screen;
a document-image acquiring unit that acquires document-image data containing a document with an image size larger than a screen size of the display unit and display control data specifying an order of reading the document and a range of the document-image data to be displayed;
a display control unit that controls, when displaying the document-image data, a display of specified range by moving a display area on the screen based on specified order; and
a determining unit that determines whether a width of the range in a line direction in acquired document-image data is wider than a width of the screen, wherein
when it is determined that the width of the range is narrower than the width of the screen, the display control unit moves the display area in a direction perpendicular to the line direction.

2. The apparatus according to claim 1, wherein when it is determined that the width of the range is wider than the width of the screen, the display control unit moves the display area in the line direction.

3. The apparatus according to claim 2, wherein the display control unit moves the display area in the line direction until an end of an arbitrary line contained in the range to be displayed, and then, moves the display area to a location including a head of a next line.

4. The apparatus according to claim 1, wherein
the document-image acquiring unit acquires the display control data that specifies the range to be displayed for each column contained in the document-image data and an order of displaying columns, and
the display control unit moves the display area to an end of an arbitrary column contained in the document-image data, and then, moves the display area to a head of another column contained in the document-image data according to the order specified in the display control data.

5. The apparatus according to claim 1, wherein
the document-image acquiring unit acquires the display control data that specifies a range of image data indicating a photograph or a graphic contained in the document-image data as the range to be displayed, and
the display control unit moves the display area to the image data contained in the document-image data.

6. The apparatus according to claim 5, further comprising a selection receiving unit that receives a selection of the image data from a user, wherein
when the selection receiving unit receives the selection of the image data, the display control unit moves the display area to a range including the image data.

7. The apparatus according to claim 5, wherein
the document-image acquiring unit acquires the display control data that specifies an association between a range representing the image data contained in the document-image data and an image corresponding area having a description corresponding to the image data within an area representing the document, and
the display control unit moves the display area from the image corresponding area to the range representing the image data associated with the image corresponding area.

8. The apparatus according to claim 5, wherein the display control unit controls a display of an icon indicating the range to be displayed.

9. The apparatus according to claim 5, wherein the display control unit controls a display of a thumbnail indicating the image data when an area representing the image data is specified in the range to be displayed.

10. The apparatus according to claim 1, further comprising a scaling processing unit that performs a scaling process on the document image data, wherein
the display control unit moves the display area to a range of the document-image data on which the scaling process has been performed.

11. An information processing device comprising:
a document-image acquiring unit that acquires document-image data containing a document;
a document-element extracting unit that extracts a document element indicating a predetermined unit of document from acquired document-image data;
a reading-order specifying unit that specifies an order of reading extracted document element; and
a display-control-data generating unit that generates display control data for the document-image data containing a range of the extracted document element to be displayed and specified order of reading the document element.

12. The information processing device according to claim 11, wherein
the document-element extracting unit further extracts a line direction of the extracted document element, and
the display-control-data generating unit generates the display control data further containing extracted line direction.

13. A method of displaying a document-image, comprising:
acquiring document-image data containing a document with an image size larger than a screen size of a display unit and display control data specifying an order of reading the document and a range of the document-image data to be displayed;
controlling, when displaying the document-image data, a display of specified range by moving a display area on the screen based on specified order; and
determining whether a width of the range in a line direction in acquired document-image data is wider than a width of the screen, wherein
when it is determined that the width of the range is narrower than the width of the screen, the controlling includes moving the display area in a direction perpendicular to the line direction.

14. The method according to claim 13, wherein when it is determined that the width of the range is wider than the width of the screen, the controlling includes moving the display area in the line direction.

15. The method according to claim 14, wherein the controlling includes moving the display area in the line direction until an end of an arbitrary line contained in the range to be displayed, and then, moving the display area to a location including a head of a next line.

16. The method according to claim 13, wherein
the acquiring includes acquiring the display control data that specifies the range to be displayed for each column contained in the document-image data and an order of displaying columns, and
the controlling includes moving the display area to an end of an arbitrary column contained in the document-image data, and then, moving the display area to a head of another column contained in the document-image data according to the order specified in the display control data.

17. The method according to claim 13, wherein
the acquiring includes acquiring the display control data that specifies a range of image data indicating a photograph or a graphic contained in the document-image data as the range to be displayed, and
the controlling includes moving the display area to the image data contained in the document-image data.

18. The method according to claim 17, wherein the controlling includes controlling a display of an icon indicating the range to be displayed.

19. The method according to claim 17, wherein the controlling includes controlling a display of a thumbnail indicating the image data when an area representing the image data is specified in the range to be displayed.

20. The method according to claim 13, further comprising performing a scaling process on the document image data, wherein
the controlling includes moving the display area to a range of the document-image data on which the scaling process has been performed.
